(19) United States
(12) Patent Application Publication
(10) Pub. No.: US 2007/0168561 A1
(43) Pub. Date: Jul. 19, 2007

(54) E-mail management systems and methods

(75) Inventors: Ming-Ta Hsu, Jhubei City (TW); Rong-Wei Chen, Hsinchu City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Taiwan Semiconductor Manufacturing Co., Ltd.

(21) Appl. No.: 11/302,640

(22) Filed: Dec. 14, 2005

(51) Int. Cl. G06F 15/16

(52) U.S. Cl. 709/247

(57) ABSTRACT

Systems and methods for e-mail management. An event indicating that an image is stored in a reserved section of storage is received. The stored image is acquired from the reserved section of storage. The acquired image is compressed. The compressed image carried by an e-mail is transmitted to a destination.

### BACKGROUND

The invention relates to e-mail management, and more particularly, to systems and methods of e-mail size reduction.

Numerous images are often directly attached to e-mails or included in files attached to e-mails. Emails containing many large-size pictures, however, consume excessive storage capacity and transmission bandwidth, resulting in poor performance of the e-mail system. The contained image are often compressed to represent an original image in fewer bits or bytes. Thus, the amount of bandwidth required to transmit these e-mails via a network can be reduced significantly. Image compression becomes an increasingly important in an e-mail management environment, as it reduces costs associated with bandwidth requirements, input/output (I/O) overhead, and communication delays.

### SUMMARY

E-mail management methods are provided. An embodiment of an e-mail management method, performed by a computer, receives an event indicating that an image is stored in a reserved section of storage. The stored image is then acquired from the reserved section of storage. The acquired image is compressed. The compressed image is then transmitted and carried by an e-mail to a destination.

The method may further store the compressed image in the reserved section of storage to replace the original image, wherein the compressed image stored in the reserved section of the storage is inserted into the e-mail via a paste instruction.

The method may further acquire at least one compression parameter setting, and the acquired image is compressed contingent upon the compression parameter setting. The compression parameter setting may correspond to image resolution, compression format, color scale or compression rate. The compression parameter setting may be stored in a configuration file. Conversely, the compression parameter setting may be stored in a check item property of a pop-up menu object, and when a check item corresponding to the check item property is selected or deselected, the compression parameter setting is updated accordingly.

A machine-readable storage medium storing a computer program which, when executed, performs an embodiment of a method of e-mail management is also provided.

Systems for e-mail management are provided. An embodiment of a system for e-mail management comprises a computer. The computer receives an event indicating that an image is stored in a reserved section of storage, acquires the stored image from the reserved section of storage, compresses the acquired image and transmits the compressed image carried by an e-mail to a destination.

In an aspect, the computer may further store the compressed image in the reserved section of storage to replace the original image. The compressed image stored in the reserved section of storage may be inserted into the e-mail via a paste instruction. The e-mail may be transmitted via a MUA (mail user agent) resident in the computer and a MTA (mail transfer agent) resident in a remote computer.

In an aspect, the computer may further acquire at least one compression parameter setting, and the acquired image is compressed contingent upon the compression parameter setting. The compression parameter setting may correspond to image resolution, compression format, color scale or compression rate. The compression parameter setting may be stored in a configuration file. And conversely, the compression parameter setting may be stored in a check item property of a pop-up menu object, and when a check item corresponding to the check item property is selected or deselected preferably via a GUI (graphic user interface), the compression parameter setting is updated accordingly.

The storage may be a memory or a file. The reserved section of storage may be a clipboard used as a temporary holding area for the image been copied or moved from an application to a MUA (mail user agent) using copy and paste and cut and paste (move) instructions. The e-mail may be transmitted via a MUA and a MTA (mail transfer agent).

### BRIEF DESCRIPTION OF THE DRAWINGS

The invention will become apparent by referring to the following detailed description of embodiments with reference to the accompanying drawings, wherein:

FIG. 1 is a diagram of the network architecture of an embodiment of an e-mail management system;

FIG. 2 is a diagram of a hardware environment applicable to a client computer or a server computer in an embodiment of an e-mail management system;

FIGS. 3 and 4 are flowchart showing embodiments of a method of e-mail management;

FIG. 5 is a diagram of a-storage medium storing a computer program providing an embodiment of a method of e-mail management;

FIG. 6 is a diagram of a storage medium storing a computer program providing an embodiment of a method for e-mail management.

### DESCRIPTION

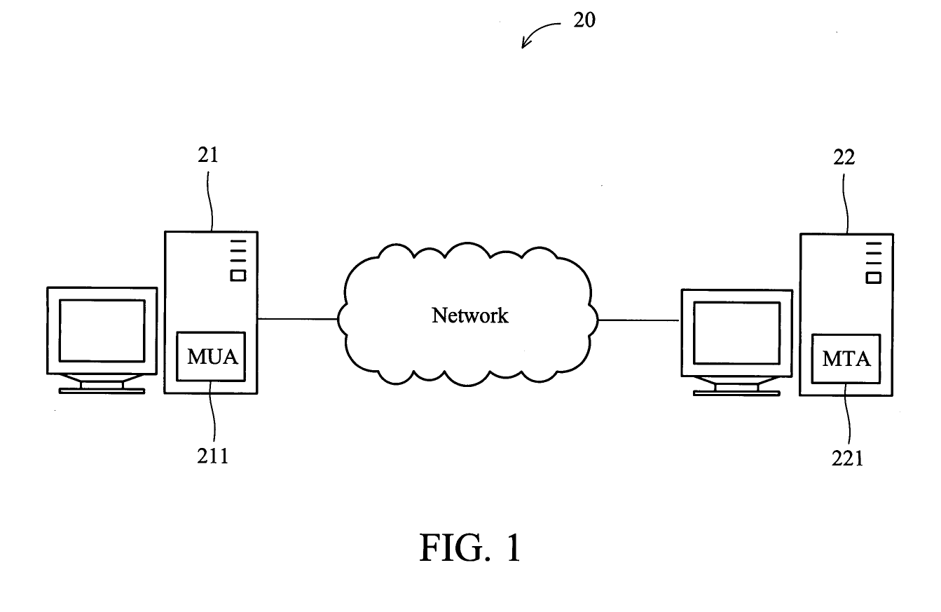

FIG. 1 is a diagram of the network architecture of an embodiment of an e-mail management system 20, comprising a client computer 21 and a server computer 22. The server computer 22 comprises a message transfer agent (MTA) 221 and the client computer 21 comprises a mail user agent (MUA) 211. The MTA 221, also called a mail server or a mail exchange server, is a computer program or software agent transferring electronic mail messages from one computer to another. The MTA 221 runs in the background, while a user interacts with another program, the MUA 211 contacts the MTA 221 for actual delivery of the mail. The MTA 221 may be configured to support SMTP (Simple Mail Transfer Protocol) and/or MIME (Multipurpose Internet Mail Extensions). SMTP, being a part of the TCP/IP protocol suite, defines the message formats and specifications of a MTA to store and forward e-mails. MIME is a communications protocol allowing transfer of data in many forms, such as audio, binary or video. SMTP is originally designed for only plain text (ASCII text), but MIME and other encoding methods enable executable programs and multimedia files to be attached to and transported with the e-mail message. SMTP servers route SMTP messages throughout the Internet to a mail server providing a message storage area for incoming e-mail. The MUA 211 also provides a GUI (graphic user interface) to facilitate creation, modification, deletion and transmission of e-mails.

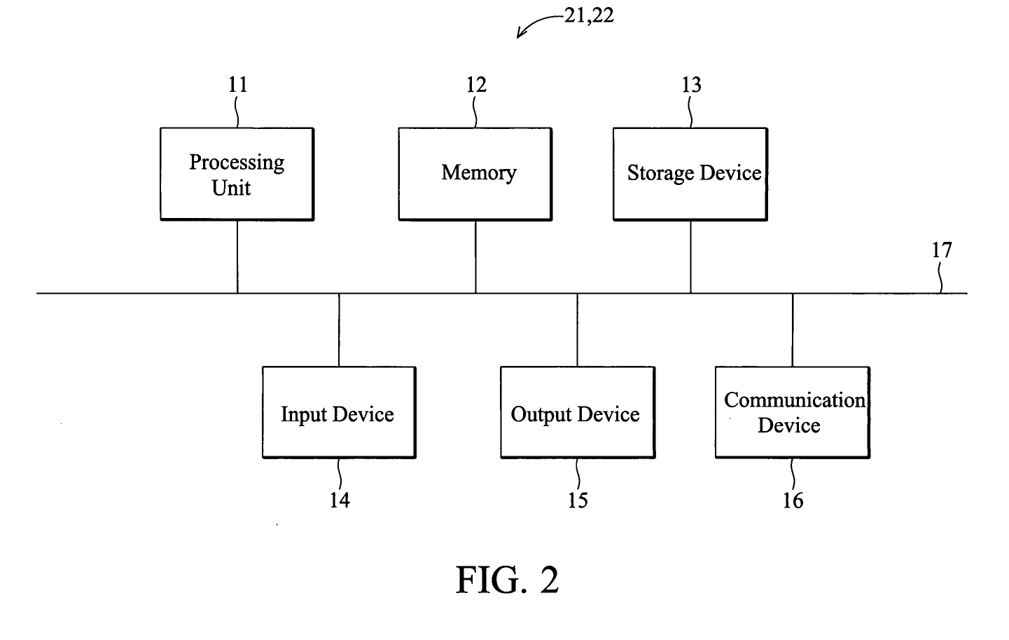

FIG. 2 is a diagram of a hardware environment applicable to the client computer 21 and server computer 22 in an embodiment of an e-mail management system. The hardware environment of FIG. 2 includes a processing unit 11, a memory 12, a storage device 13, an input device 14, an output device 15 and a communication device 16. The processing unit 11 is connected by buses 17 to the memory 12, storage device 13, input device 14, output device 15 and communication device 16 based on Von Neumann architecture. There may be one or more processing units 11, such that the processor of the computer comprises a single central processing unit (CPU), a micro processing unit (MPU) or multiple processing units, commonly referred to as a parallel processing environment. The memory 12 is preferably a random access memory (RAM), but may also include read-only memory (ROM) or flash ROM. The memory 12 preferably stores program modules executed by the processing unit 11 to perform e-mail management functions. Generally, program modules include routines, programs, objects, components, scripts, Web pages, or others, that perform particular tasks or implement particular abstract data types. Moreover, those skilled in the art will understand that some embodiments may be practiced with other computer system configurations, including hand-held devices, multiprocessor-based, microprocessor-based or programmable consumer electronics, network PCs, minicomputers, mainframe computers, and the like. Some embodiments may also be practiced in distributed computing environments where tasks are performed by remote processing devices linked via a communication network. In a distributed computing environment, program modules may be located in both local and remote memory storage devices based on various remote access architecture such as DCOM, CORBA, Web objects, Web Services or other similar architectures. The storage device 13 may be a hard drive, magnetic drive, optical drive, portable drive, or nonvolatile memory drive. The drives and associated computer-readable media thereof (if required) provide nonvolatile storage of computer-readable instructions, data structures and program modules. The processing unit 11, controlled by program-modules received from the memory 12 and from an operator via the input device, directs e-mail management functions.

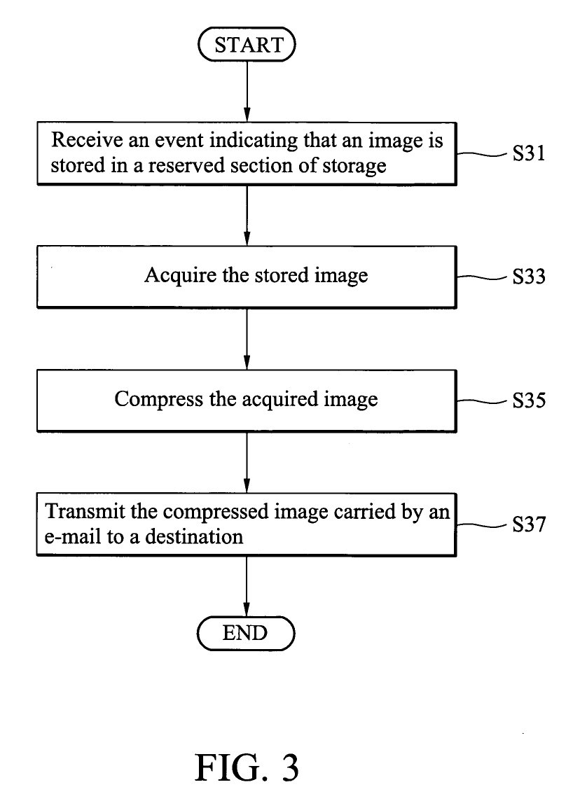

An embodiment of an e-mail management method employed by the client computer 21 is described in the following. FIG. 3 is a flowchart showing an embodiment of a method of e-mail management. In step S31, an event indicating that an image is stored in a reserved section of storage is received. In step S33, the stored image is acquired from the reserved section of storage. In step S35, the acquired image is compressed. In step S37, the compressed image carried by an e-mail is transmitted to a destination.

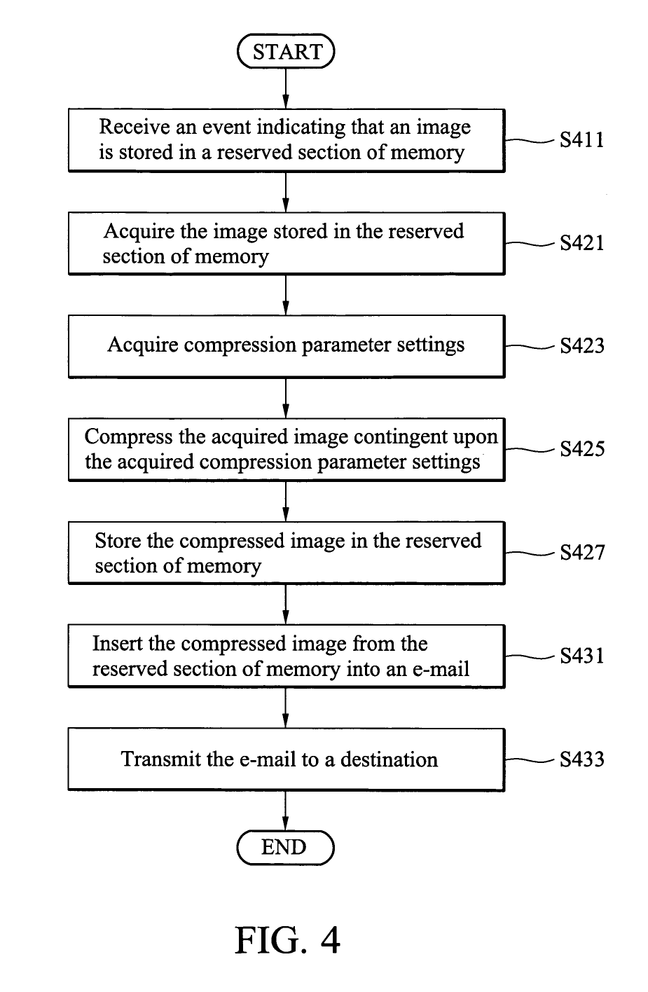

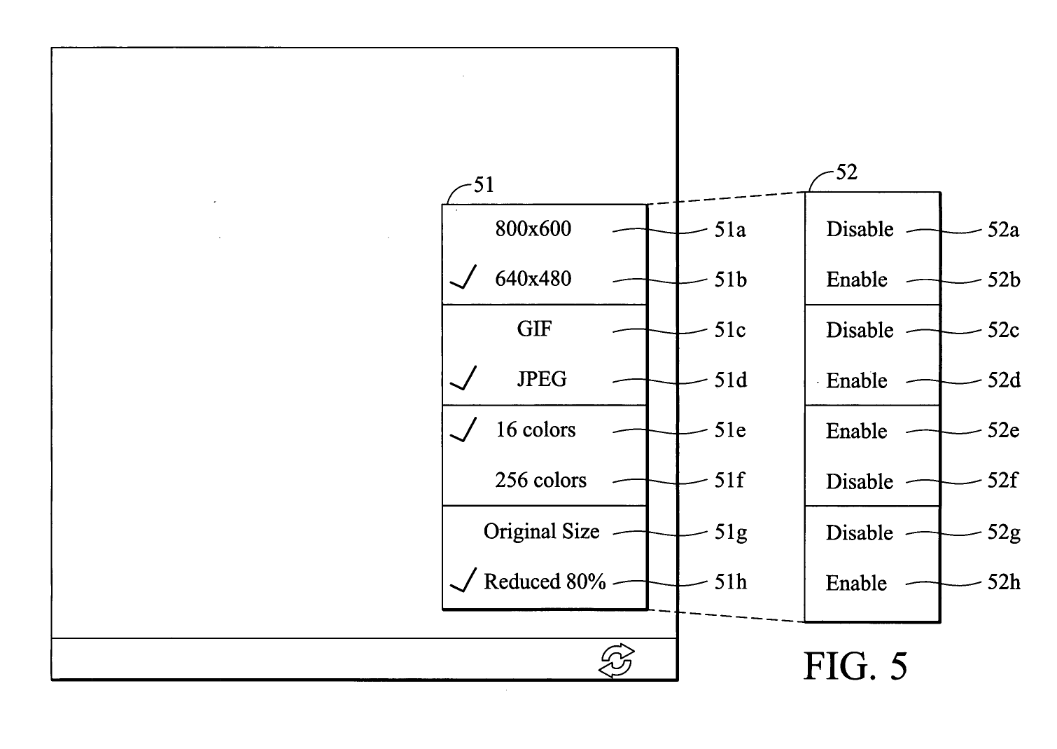

An embodiment of an e-mail management method employed by the client computer 21 is described in the following. FIG. 4 is a flowchart showing an embodiment of a method of e-mail management. In step S411, an event indicating that an image is stored in a reserved section of memory 12 is received. Those skilled in the art will realize that the reserved section may be implemented in a file stored in the storage device 13. The reserved section of memory 12 may preferably be a clipboard used as a temporary holding area for an image that is copied or moved from one application, such as a graphic editor, word processing editor and the like, to another, such as a MUA, word processing and the like, using the copy and paste and cut and paste (move) instructions. Each time an image is transferred into the clipboard, the previous contents are deleted. The clipboard functions in the background, holding an image for pasting (inserting) into a GUI provided by the MUA. In step S421, the image stored in the reserved section of memory 12 is acquired. In step S423, compression parameter settings, such as image resolution, compression format (e.g. JPEG, GIF and the like), color scales, compression rate and combinations thereof, are 10 acquired. The compression parameter settings may be stored in a configuration file or a pop-up menu object. Such compression parameter settings are preferably stored in check item properties of the pop-up menu object, thereby enabling to efficient selection or deselection of check items to adjust particular compression settings. FIG. 5 is a screen diagram showing an exemplary pop-up menu 51 comprising several check items, 51a to 51h, used to configure compression parameter settings. Check items 51a to 51b, 51c to 51d, 51e to 51f, and 51g to 51h are respectively employed to adjust image resolution, compressed format, color scale and compression rate settings. The pop-up menu 51 corresponds to a pop-up menu object 52, a particular data type, and the displayed check item 51a to 51h and selection settings thereof are recorded in relevant check item properties 52a to 52h. When a check item is selected or deselected, the corresponding check item property is updated accordingly.

Referring to FIG. 4, in step S425, the acquired image is compressed contingent upon the acquired compression parameters. In step S427, the compressed image is stored in the reserved section of memory 12. In step S431, the compressed image stored in the reserved section of memory 12 is inserted into an e-mail. The compressed image may be alternately inserted into a file, such as a word processing file, spread sheet, brief representation file and the like. The file is subsequently attached to an e-mail. In step S433, the composed e-mail is transmitted to a destination via the MUA 211 and MTA 221.

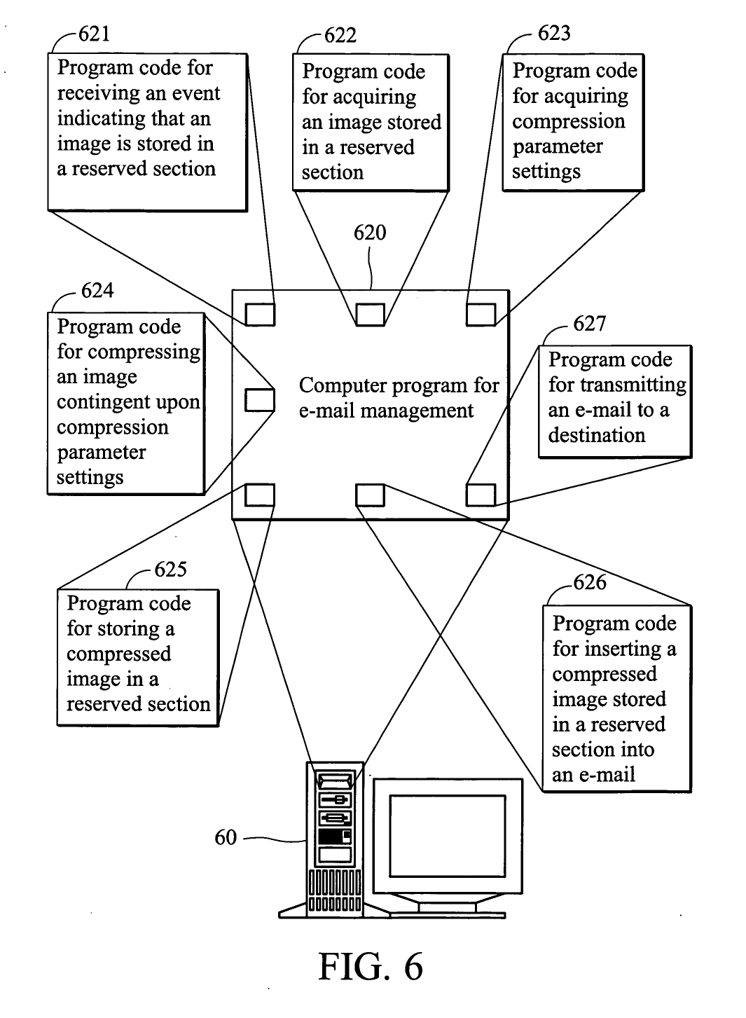

Also disclosed is a storage medium as shown in FIG. 6 storing a computer program 620 providing the disclosed method of e-mail management. The computer program product includes a storage medium 60 having computer readable program code embodied therein for use in a computer system. The computer readable program code comprises at least computer readable program code 621 receiving an event indicating that an image is stored in a reserved section, computer readable program code 622 acquiring an image stored in a reserved section, computer readable program code 623 acquiring compression parameter settings, computer readable program code 624 compressing an image contingent upon compression parameter settings, computer readable program code 625 storing a compressed image in a reserved section, computer readable program code 626 inserting a compressed image stored in a reserved section into an e-mail, and computer readable program code 627 transmitting an e-mail to a destination.

E-mail management systems and methods, or certain aspects or portions thereof, may take the form of program code (i.e., instructions) embodied in tangible media, such as floppy diskettes, CD-ROMS, hard drives, or any other machine-readable storage medium, wherein, when the program code is loaded into and executed by a machine, such as a computer, the machine becomes an apparatus for practicing the invention. The disclosed methods and systems may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the invention. When implemented on a general-purpose processor, the program code combines with the processor to provide a unique apparatus that operates analogously to specific logic circuits.

Although the invention has been described in terms of preferred embodiment, it is not intended to limit the invention thereto. Those skilled in this technology can make various alterations and modifications without departing from the scope and spirit of the invention. Therefore, the scope of the invention shall be defined and protected by the following claims and their equivalents.

What is claimed is:

1. A method of e-mail management comprising using a computer to perform the steps of:
receiving an event indicating that an original image is stored in a reserved section of storage;
acquiring the stored original image from the reserved section of storage;
compressing the acquired original image; and
transmitting the compressed image carried by an e-mail to a destination.

2. The method of claim 1 further comprising a step of storing the compressed image in the reserved section of storage to replace the original image, and wherein the compressed image stored in the reserved section of the storage is inserted into the e-mail via a paste instruction.

3. The method of claim 1 wherein the storage is a memory or a file.

4. The method of claim 1 wherein the reserved section of storage is a clipboard used as a temporary holding area for the original image and compressed image been copied or moved from an application to a MUA (mail user agent) using copy and paste and cut and paste (move) instructions.

5. The method of claim 1 wherein the e-mail is transmitted via a MUA (mail user agent) and a MTA (mail transfer agent).

6. The method of claim 1 further comprising a step of acquiring at least one compression parameter setting, and wherein the acquired original image is compressed contingent upon the compression parameter setting.

7. The method of claim 6 wherein the compression parameter setting corresponds to image resolution, compression format, color scale or compression rate.

8. The method of claim 6 wherein the compression parameter setting is stored in a configuration file.

9. The method of claim 6 wherein the compression parameter setting is stored in a check item property of a pop-up menu object, and when a check item corresponding to the check item property is selected or deselected, the compression parameter setting is updated accordingly.

10. A machine-readable storage medium storing a computer program which, when executed, performs a method for e-mail comprising:
receiving an event indicating that an image is stored in a reserved section of storage;
acquiring the stored image from the reserved section of storage;
compressing the acquired image; and
transmitting the compressed image carried by an e-mail to a destination.

11. A system for e-mail management, comprising:
a computer receiving an event indicating that an oringal image is stored in a reserved section of storage, acquiring the stored oringal image from the reserved section of storage, compressing the acquired oringal image and transmitting the compressed image carried by an e-mail to a destination.

12. The system of claim 11 wherein the computer stores the compressed image in the reserved section of storage to replace the original image, and the compressed image stored in the reserved section of storage is inserted into the e-mail via a paste instruction.

13. The system of claim 11 wherein the storage is a memory or a file.

14. The system of claim 11 wherein the reserved section of storage is a clipboard used as a temporary holding area for the image been copied or moved from an application to a MUA (mail user agent) using copy and paste-and cut and paste (move) instructions.

15. The system of claim 11 the e-mail is transmitted via a MUA (mail user agent) resident in the computer and a MTA (mail transfer agent) resident in a remote computer.

16. The system of claim 11 wherein the computer acquires at least one compression parameter setting, and the acquired image is compressed contingent upon the compression parameter setting.

17. The system of claim 16 wherein the compression parameter setting corresponds to image resolution, compression format, color scale or compression rate.

18. The system of claim 16 wherein the compression parameter setting is stored in a configuration file.

19. The system of claim 16 wherein the compression parameter setting is stored in a check item property of a pop-up menu object, and when a check item corresponding to the check item property is selected or deselected, the compression parameter setting, is updated accordingly.

20. The system of claim 19 wherein the check item corresponding to the check item property is selected or deselected via a GUI (graphic user interface).
